(19) United States
(12) Patent Application Publication
(10) Pub. No.: US 2025/0183769 A1
(43) Pub. Date: Jun. 5, 2025

(54) ASSEMBLY FOR FORMING WINDINGS FOR ELECTRIC MACHINES

(71) Applicant: ATOP S.P.A., Barberino Tavarnelle (IT)

(72) Inventors: Filippo PROFETI, Poggibonsi (IT); Giovanni CALVO, Barberino Tavarnelle (IT)

(21) Appl. No.: 18/729,132

(22) PCT Filed: Mar. 3, 2023
(86) PCT No.: PCT/EP2023/055414

§ 371 Date: Jul. 15, 2024

(30) Foreign Application Priority Data
Mar. 8, 2022 (IT) 102022000004298

(51) Int. Cl. H02K 15/0643; H02K 15/40

(52) U.S. Cl. CPC H02K 15/0643; H02K 15/40; H02K 2215/00

(57) ABSTRACT

An assembly for forming windings for electric machines, comprising: a supporting frame, a collection drum which has a central axis of symmetry and is supported on a plane of arrangement of the frame wherein the drum has a plurality of seats arranged according to a predefined distribution; at least one grip element which is configured to pick up at least one electrically conductive element from a delivery station and to move the picked-up element up to the insertion at least of a portion of interest of the element in a seat of the drum.

The assembly comprises means for translation which are configured to translate the drum on the plane of arrangement so as to vary the position of the central axis of the drum on the plane of arrangement.

The present invention relates to an assembly for forming windings for electric machines, in particular for the anticipatory arrangement of the wires of a stator (or rotor) winding of a rotating electric machine.

As is known, the stator of an electric motor or of an electricity generator (and/or of other rotating electric machines) comprises a ferromagnetic core and a plurality of coils or windings (inductive), which are arranged according to various geometries with respect to the core. A current circulating in at least one winding can determine, by electromagnetic induction, the circulation of an induced current in at least one other winding. Furthermore, with reference for example to an electric motor, forces develop between the stator and the rotor which are capable of turning the rotor.

According to a consolidated technique for manufacturing stators, the windings are made up of a plurality of (electrically) conductive elements which are inserted separately into respective slots provided in the core of the stator and then welded to each other at the ends, in order to form the windings according to the desired configuration.

Such elements can be straight or undulating or they can take other shapes, of which one is particularly widely used in which they are substantially folded into a U-shape, thus taking on a forked shape composed of two straight tines connected by a transverse bridge (in turn typically bent into a U-shape or a V-shape).

When it assumes this last configuration, the element is identified using the English term “hairpin” and it is coupled to the core by inserting each tine into a corresponding slot of the core.

In any case, for all the shape structures mentioned above (and/or for others besides), conventional production and assembly lines of stators typically comprise devices that cut the elements from a respective spool and then give them the desired shape.

Subsequently, a suitably-actuated anthropomorphic robot, capable of moving a gripper freely in space according to any programmable law of motion, takes over and grips the element delivered by the devices upstream, and then moves it until it is inserted into the slots (or slot) of a model (or basket) below that replicates the distribution of the slots of the destination stator (or rotor).

Using the robot makes it possible to ensure that the line is adequately versatile: when the dimensions and/or shape of the element to be moved vary, it is sufficient to modify the law of motion imparted to the gripper in order to enable the correct operation.

Unfortunately, however, the anthropomorphic robot determines a considerable increase in the time necessary to execute the cycle of picking up and placing each hairpin (conductive element), thus reducing the potential productivity of literally all the other processing components and stations present in the production plant. In addition the costs of the robot determine a corresponding increase of the costs of the entire plant.

For this reason pick and place stations for conductive elements (hairpins) have been created which are fitted with movement apparatuses of the Cartesian type, which are far more rapid and more economic than an anthropomorphic arm. However, Cartesian movement apparatuses operate using predefined laws motion in which the coordinates for picking and placing are fixed, i.e. they do not allow adjustments of the position of the conductive element (hairpin) in order to facilitate the access of the respective tines into the slots (or into the slot) of the model (or basket) below, replicating the distribution of the slots of the destination stator (or rotor). But such adjustments are possible when using an anthropomorphic robot.

The use of pickup grippers actuated by a Cartesian movement apparatus is therefore complex and difficult to reconcile with the need to ensure a perfect positioning of the tines of each conductive element in the respective seats of the model, not least in relation to the fact that such elements can exhibit slight deformations with respect to the ideal geometry, which hinder their correct alignment with the seats.

The aim of the present invention is to solve the above mentioned drawbacks, by providing an assembly for forming windings for electric machines that enables the easy insertion of the tines of the conductive elements (hairpins) into respective seats by way of a gripper actuated by a Cartesian movement apparatus.

Within this aim, an object of the invention is to provide an assembly for forming windings for electric machines that makes it possible to execute positioning adjustments for the alignment of the tines of the conductive elements (hairpins) and of the respective seats.

Another object of the invention is to provide an assembly for forming windings for electric machines that makes possible a reduction of the times of each cycle for picking and placing the conductive elements (hairpins) in the seats of a model (or basket) that replicates the distribution of the slots of the destination stator (or rotor), with respect to what is possible in the known art.

Another object of the invention is to provide an assembly for forming windings for electric machines that adopts components that are subjected to substantially simple control logic.

Another object of the invention is to provide an assembly for forming windings for electric machines that is versatile, i.e. that is adapted to forming windings intended for different types of stators (or rotors) of electric machines.

Another object of the present invention is to provide an assembly for forming windings for electric machines which is of low cost, easily and practically implemented and safe in use.

This aim and these objects are achieved by an assembly for forming windings for electric machines, which comprises a supporting frame for a collection drum which is provided with a plurality of seats arranged according to a predefined distribution and for at least one grip element which is configured to pick up at least one electrically conductive element from a delivery station and to move the element up to the insertion at least of a portion of interest of the element in a specific destination seat of the drum, characterized in that said drum comprises a plurality of radial seats which extend between an inner edge, arranged at a first predefined distance from the central axis of said drum, and an outer edge, arranged at a second predefined distance from the central axis of said drum, interposed between said drum and said frame are means for movement of said drum with respect to said frame, which are configured for the adjustment of the position and the orientation of said drum.

Further characteristics and advantages of the invention will become better apparent from the detailed description that follows of a preferred, but not exclusive, embodiment of the assembly for forming windings for electric machines, which is illustrated by way of non-limiting example in the accompanying drawings wherein:

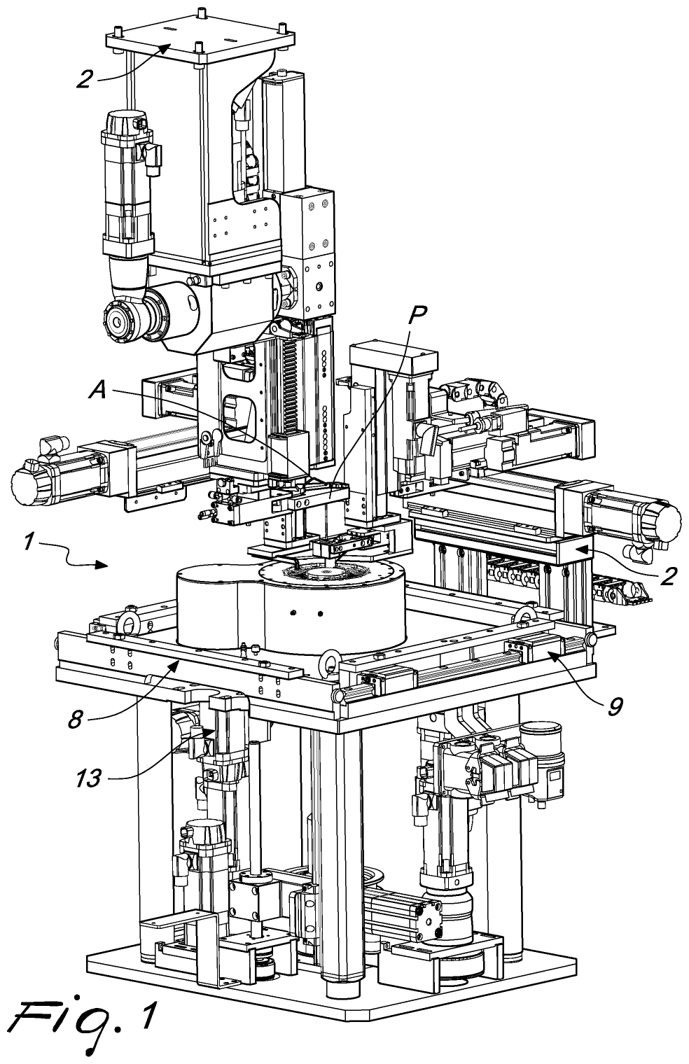

FIG. 1 is a schematic perspective view of a possible embodiment of an assembly according to the invention installed in a respective station of a plant for manufacturing windings of electric machines;

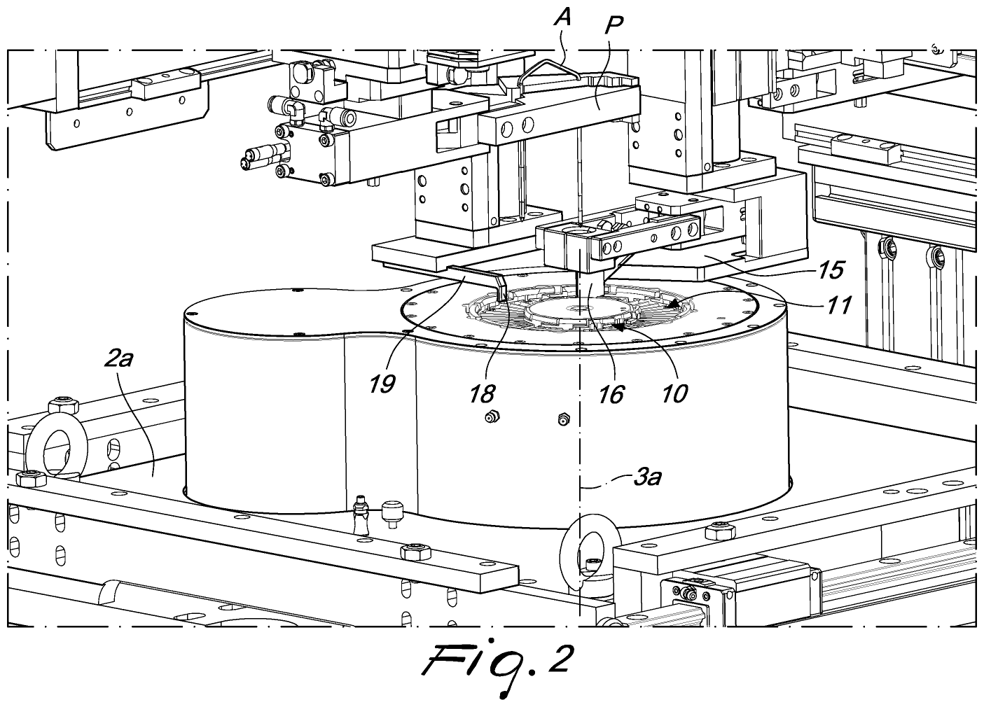

FIG. 2 is a schematic view from above of an enlarged detail of FIG. 1;

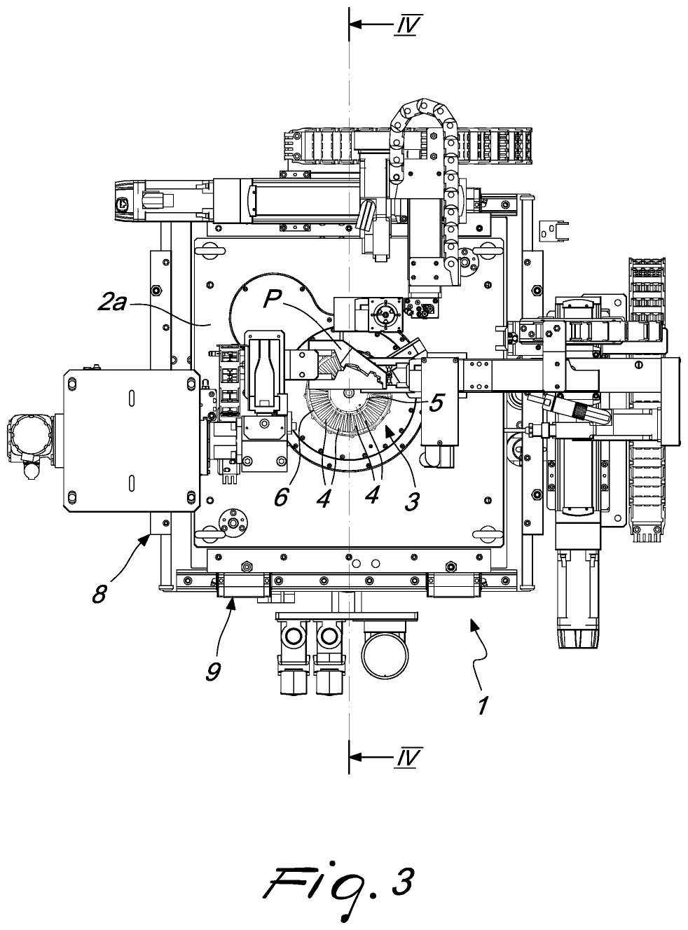

FIG. 3 is a schematic perspective view of the plant of FIG. 1 comprising the assembly according to the invention;

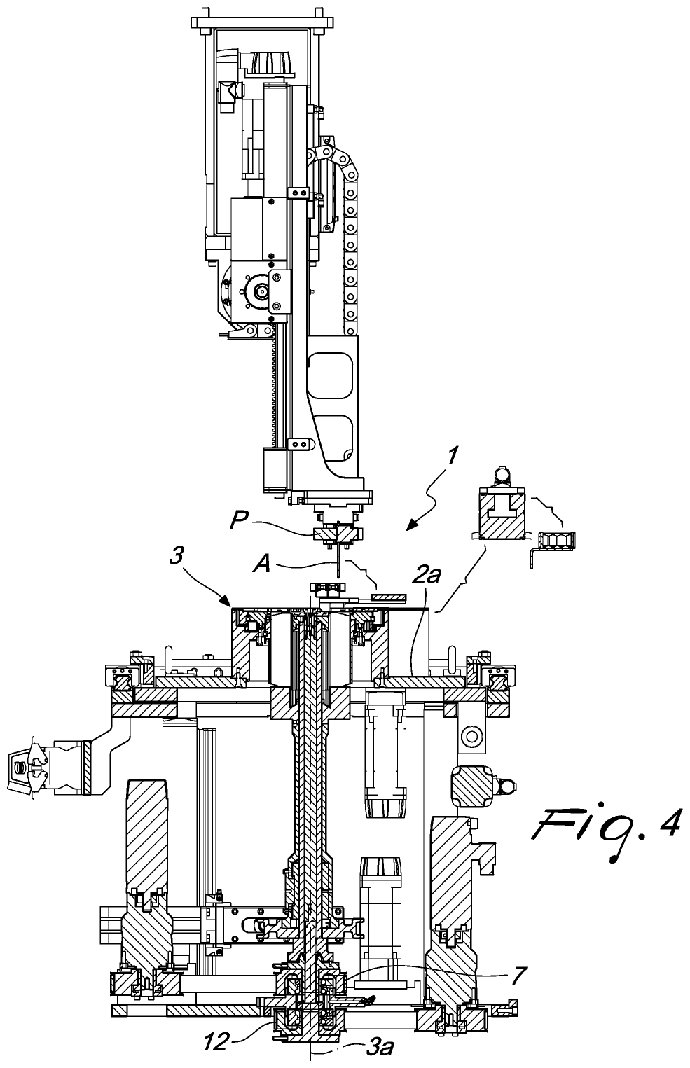

FIG. 4 is a cross-sectional view taken along the plane IV-IV in FIG. 3;

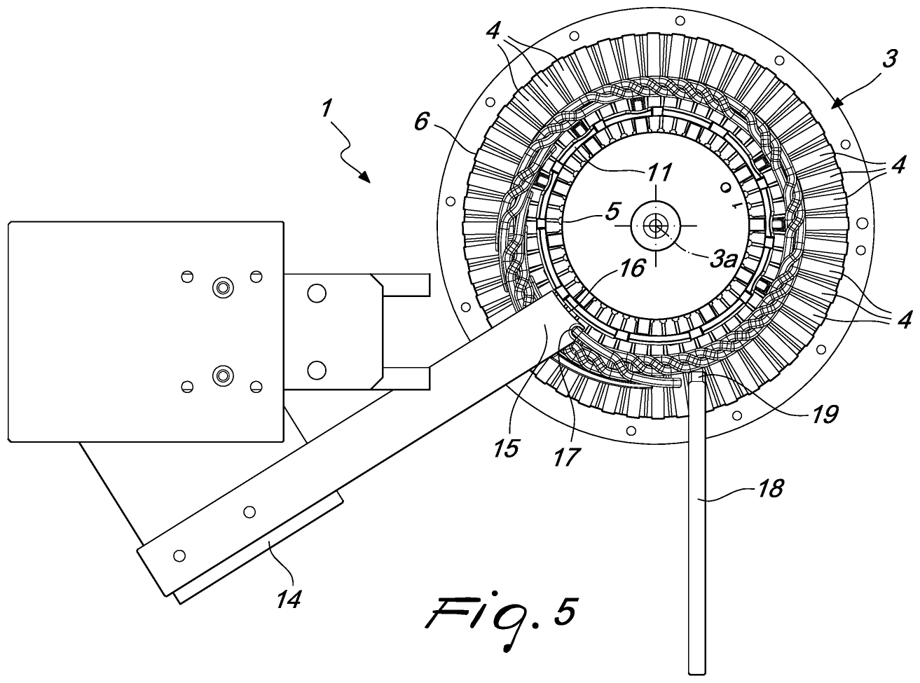

FIG. 5 is a schematic view from above of a portion of the assembly of FIG. 1;

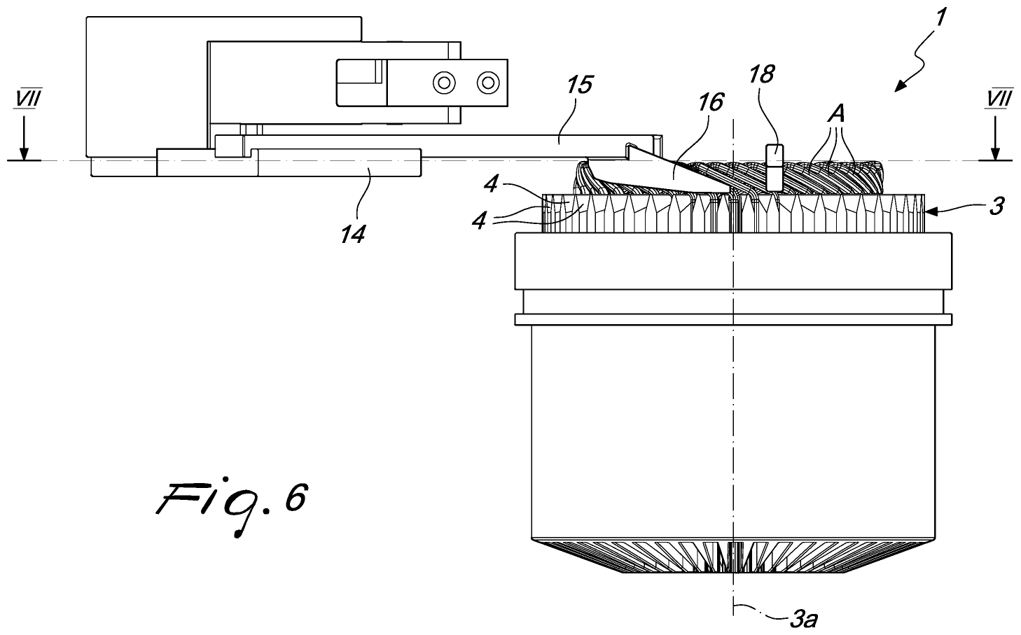

FIG. 6 is a schematic side view of the portion of FIG. 3 of the assembly according to the invention;

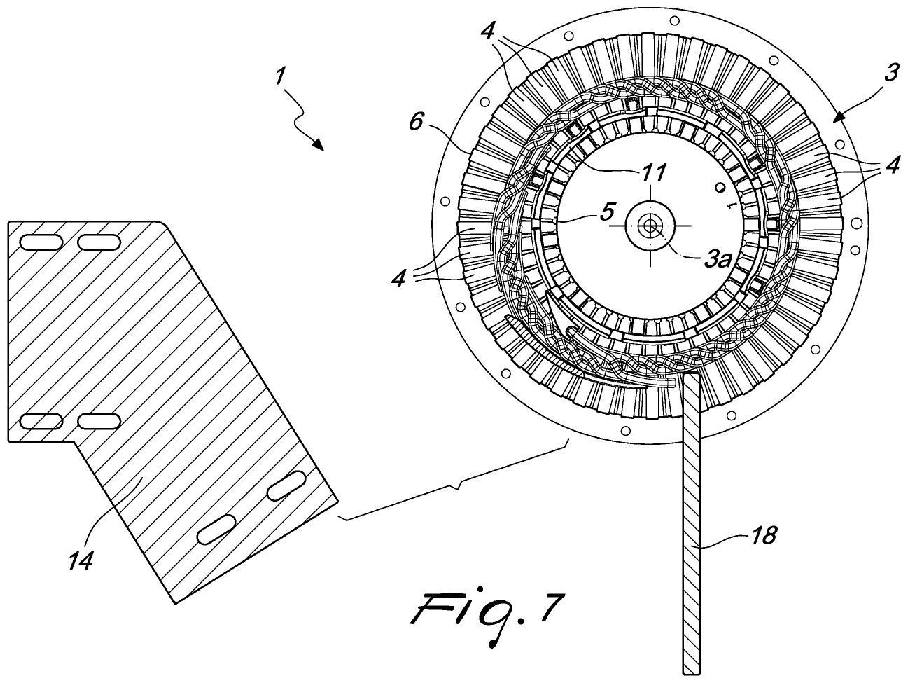

FIG. 7 is a cross-sectional view taken along the plane VII-VII in FIG. 6.

With reference to the figures, the reference numeral 1 generally designates an assembly for forming windings for electric machines, with particular reference to stator and/or rotor windings of rotating electric machines, such as motors, dynamos, alternators and the like.

The assembly 1 according to the invention comprises a supporting frame 2 which carries (on a plane 2a of arrangement of the frame 2) a collection drum 3 which has an axis of symmetry 3a; the drum 3 is provided with a plurality of seats 4 which are arranged according to a predefined distribution.

The frame 2 is further designed to support at least one grip element P which is configured to pick up at least one electrically conductive element A (generally constituted by a shaft of conductive material, optionally contoured according to predefined geometries) from a delivery station (not shown in the accompanying figures) and to move the picked-up element A up to the insertion at least of a portion of interest of the element A in a specific destination seat 4 of the drum 3.

Each seat 4 of the plurality of radial seats 4 which extend between an inner edge 5, i.e. arranged at a first predefined distance from the central axis 3a of the drum 3 (i.e. its longitudinal axis of symmetry), and an outer edge 6, arranged at a second predefined distance from the central axis of the drum 3, greater than the first distance.

This specific shape structure of the seats 4 implies that they can have a width that is substantially predefined (and which in any case conforms to the width of the seats of conventional drums) and a length (extension in a radial direction, with particular reference to the shape of the drum 3) that corresponds to the distance (in a radial direction) of the inner edge 5 from the outer edge 6 (therefore a much greater length than that of the seats of conventional drums). In more detail, it can be said that the seats 4 according to the invention have a diameter of their inner edge 5 that is much smaller than what is found in the known art.

It should furthermore be noted that, according to the invention, interposed between the drum 3 and the frame 2 there can conveniently be means for translation which are configured to translate the drum 3 on the plane 2a of arrangement (and therefore translating them with respect to the frame 2), so as to vary the position of the central axis 3a of the drum 3 on the plane 2a of arrangement (such means for translation are therefore configured for the adjustment of the position and the orientation of the drum 3).

This particular implementation architecture therefore ensures that if the at least one grip element P is actuated by a movement apparatus of the Cartesian type (which therefore does not allow the fine adjustment of the point of delivery of the element A clamped in it) it is possible to ensure the necessary alignment of each portion of the element A with a corresponding seat 4 of the drum 3 through adjustments of position of the drum 3 executed using the means for translation of the drum 3 on the plane 2a and, therefore, with respect to the frame 2.

The principal advantage of this embodiment consists in the fact that the adjustment of the position of the drum 3 (therefore the exact location of the respective axis 3a on the plane 2a) can be executed in advance (for example during an optional change of format of the elements A being processed) or during the transfer of the element A from the delivery station to said drum 3. It can be seen therefore that such adjustment of the position of the axis 3a of the drum 3 can be executed at the same time as other planned operations in the plant (using the method known as “running in the background”), without resulting in any increase in the operating times of said plant to execute each operating cycle.

It is therefore evident that the assembly 1 according to the invention makes it possible to maximize the speed of production and therefore the efficiency of the plant in which it is installed.

With particular reference to an embodiment of undoubted practical and applicative interest, the means for rotation of the drum 3, with respect to the fixed frame 2, comprise a rotatable actuator 7 for the rotation of the drum with respect to its own axis of symmetry 3a, until an alignment of at least one respective seat 4 thereof with at least one corresponding portion of interest of an element A gripped by the grip element P is obtained.

Profitably it is envisaged that the means for movement of the drum 3 on the plane 2a of the frame 2 can comprise at least one linear actuator 8, 9 for the translation of the drum 3 along a first direction defined on the plane of arrangement.

In an embodiment of maximum operating efficiency, the means for movement of the drum 3 with respect to the plane 2a of the frame 2 positively comprise two linear actuators 8, 9 which operate along perpendicular directions for the translation of the drum 3 respectively along a first direction which is defined on the plane 2a of arrangement of the drum 3 and a second direction which is perpendicular to and co-planar with the first direction.

In practice therefore, the drum 3 can be moved on the plane 2a of arrangement for the purpose of arranging the axis of symmetry 3a of said drum 3 in the ideal position that makes it possible to align the respective seats 4 with the portions of respective elements A that will need to be inserted in them.

It is evident that an embodiment that comprises the rotatable actuator 7 and the at least two linear actuators 8, 9 makes it possible to execute any adjustment of position on the plane 2a of arrangement of the drum 3 (in particular of the axis 3a). In this manner it is possible to ensure that the portions of the element A are always aligned with the seats 4 in which they are to be inserted even if the element P follows a law of motion (along Cartesian axes) that does not allow adjustments thereof. It will in fact be the drum 3 that will be moved, in order to bring the respective seats 4 to the ideal position that enables them to receive the respective portions of the element A.

In order to ensure an optimal arrangement of the various portions of elements A which have already been inserted in the seats 4 of the drum 3, it should be noted that the assembly 1 according to the invention can advantageously comprise at least one slider 10, 11 which can move in a radial direction with respect to the central axis 3a within each seat 4 for the compaction of the portions of the element A that are present within the seat 4 (i.e. inside the seat).

The at least one slider 10, 11 will usefully be movable in a radial direction with respect to the central axis 3a from one end of the seat 4 up to a predefined position thereof, by virtue of the action of at least one respective actuator 12, 13.

With particular reference to the embodiment shown in the accompanying figures (and provided solely by way of non-limiting example of the present invention), the assembly 1 can conveniently comprise two sliders 10 and 11 which can move in a radial direction with respect to the central axis 3a.

These sliders 10 and 11 will be mutually opposite within each seat 4 and their function will be to compact the portions of element A that are present within said seat 4 (i.e. inside the seat).

In particular, a first slider 10 will be movable in a radial direction with respect to the central axis 3a from an internal end of the seat 4 (proximate to the inner edge 5 of the drum 3) up to a predefined internal position of said seat 4 by virtue of the action of at least one respective actuator 12, while a second slider 11 will be movable in a radial direction with respect to the central axis 3a from an external end of the seat 4 (proximate to the outer edge 6 of the drum 3) up to a predefined external position of said seat 4 by virtue of the action of at least one respective actuator 13.

The portions of the various elements A that are present within the seat 4 are interposed and compacted between sliders 10 and 11 when the latter are respectively arranged so that the slider 10 is in the predefined internal position and the slider 11 is in the predefined external position.

It should be noted that the assembly 1 can profitably further comprise a movable arm 14 which is coupled to at least one splaying apparatus 15 which will be movable between a passive configuration, which is external to the drum 3, and an active configuration, in which a contoured edge 16 thereof is at least partially overlaid on the drum 3 and is interposed between mutually contiguous central portions of distinct elements A (by way of example such central portions can be preferably two in number) which have their terminal portions inserted in respective seats 4 of said drum 3.

The splaying apparatus 15 comprises a receptacle 17 designed for the conveyance of a portion of an additional conductive element A (which can be contiguous, in a radial direction with respect to the central axis 3a, with the elements mentioned previously) into a predefined seat 4 between further respective terminal portions (already present in the seats 4 of the drum 3) which are respectively splayed by the contoured edge 16.

By virtue of the presence of the splaying apparatus 15 it is therefore possible to separate contiguous elements A which have respective portions already inserted in the seats 4 of the drum 3, so defining a space within a predefined seat 4 of interest (a space defined in a zone facing and proximate to the receptacle 17) into which a portion of an additional element A can easily be inserted.

In this manner, even when a plurality of elements A is already arranged inside the seats 4 of the drum 3 (occupying those seats), it is possible to generate an empty space in a seat 4 of interest into which to insert a portion of an additional element A without it interfering with other portions of other elements A already inserted previously.

The intervention of the splaying apparatus 15 in combination with the abundant (greater than what is available in the known art, as illustrated above) longitudinal extension (in a radial direction with respect to the axis 3a) of the seats 4, leads to possible irregularities in the arrangement of the elements A in the seats 4 (each time the splaying apparatus 15 intervenes, some portions of specific elements A will be made translate in a radial direction with respect to the central axis 3a, respectively toward the inner edge 5 or toward the outer edge 6 of the respective seat 4). This will be remedied, once the arrangement of all the elements A has been completed, by the radial (with respect to the central axis 3a) compaction executed by the sliders 10 and 11, but it could lead to problems of temporary positioning of the elements A that are present in the seats 4 during the steps of insertion of other elements A.

In order to overcome this problem, the assembly 1 according to the invention can advantageously further comprise a locking unit 18 which will be able to move between an external, passive arrangement, separate from the drum 3, and an active arrangement in which it is partially overlaid on the drum 3, at which a terminal end 19 of the unit 18 abuts against mutually contiguous central portions of distinct elements A the terminal portions of which are inserted in respective seats 4 of the drum 3, compressing them onto each other inward into the respective seat 4.

In this manner, while the splaying apparatus 15 displaces contiguous elements A in order to facilitate the entry of the portion of an additional element into a respective seat 4 (more accessible by virtue of this displacement of the elements A already inserted previously), the unit 18 acts on the outer side of the elements A already inserted, at a predefined distance from the splaying apparatus 15. The action of the unit 18 is such as to prevent the movements induced by the splaying apparatus 15 from also having repercussions on elements A that are far from those on which it operates, in this manner facilitating the maintenance of a correct arrangement of the elements A on the drum 3, i.e. of the respective portions in the seats 4.

In more detail, the splaying apparatus 15 and the locking unit 18 will profitably abut against conductive elements A the portions of which are accommodated within respective seats 4 of the drum 3.

The splaying apparatus 15 and the locking unit 18 are substantially aligned, with appropriate mutual angular offset, with the seats 4 provided for the insertion of respective portions of an additional conductive element A clamped by the at least one grip element P.

It should be noted that the assembly 1 according to the invention can also comprise a stage that is configured for picking up a preset plurality of electrically conductive elements A distributed in the seats 4 and the respective insertion of portions thereof in the slots of a target ferromagnetic core. This stage will therefore be responsible for executing the transfer of the elements A, correctly arranged in the seats 4 of the drum 3 (to define an arrangement corresponding to that of an inductive winding of an electric machine) into the slots of a ferromagnetic core (generally a stator or a rotor of a rotating electric machine, although different applications are not ruled out) in which, by way of successive processing, respective welds will be made between the elements A for the completion of the desired inductive winding.

It should be noted that, according to a particular embodiment, the grip element P configured to move the element A can profitably perform the insertion of at least one portion of interest of the element A into a preset position with respect to the supporting frame 2.

The conveyance receptacle 17 will advantageously be configured as an opening, the orientation of which is parallel to the seats 4 in which the conductive elements A are at least partially accommodated.

The scope of the present invention also extends to a method for forming windings for electric machines, which comprises the following steps:
picking up, using a grip element P, at least one electrically conductive element A from a delivery station,
moving an element A up until the insertion at least of a portion of interest thereof in a seat 4 of a plurality of seats 4 present in a drum 3, wherein each seat 4 of the plurality of seats 4 extends radially between an inner edge 5, arranged at a first predefined distance from a central axis 3a of the drum 3, and an outer edge 6, arranged at a second predefined distance from the central axis 3a of the drum 3 and wherein the drum 3 is supported by a plane 2a of arrangement of the frame 2,
rotation of the drum 3 about a central axis 3a of said drum 3 on the plane 2a of arrangement according to an angle of predefined (and substantially limited) breadth.

According to the method defined by the present invention, an additional step is included of translating the drum 3 on the plane 2a of arrangement so as to vary the position of the central axis 3a of the drum 3 on the plane 2a of arrangement.

This additional translation of the drum 3 enables an easier insertion of the portions of an element A into the respective seats 4, by virtue of the possibility of obtaining a better mutual alignment of portions and seats 4.

It should furthermore be noted that, in the step of rotation, the drum 3 rotates until an alignment of at least one respective seat 4 thereof with at least one corresponding portion of interest of an element A gripped by the grip element P is obtained.

In the step of translation of the drum 3 on the plane 2a of arrangement, the translation occurs along at least one first direction defined on the plane 2a of arrangement.

In the step of translation of the drum 3 on the plane 2a of arrangement, the translation occurs on two mutually perpendicular directions (more precisely along those directions) which are defined on the plane 2a of arrangement.

The method can optionally also comprise a subsequent step of compaction of the portions of the elements A which are present in the seat 4, in a radial direction with respect to the central axis 3a of rotation, from a configuration of greater bulk to a configuration of less bulk.

The elements A, before the optional step of compaction, will be arranged at an unspecified mutual distance apart and therefore will occupy more space within the respective seat 4, so defining the configuration of greater bulk (bulky configuration).

By performing a compaction of the elements A, these will be brought closer together so that their surfaces will come into contact (or will at least face each other and be proximate), so eliminating the empty spaces between each element A and the contiguous element.

The compaction will therefore ensure a reduction of the overall space occupation of the elements A arranged within the seat 4, thus identifying a configuration of minimum encumbrance thereof (minimum bulk configuration).

The method can further comprise an additional subsequent step of movement in order to splay two mutually radially contiguous central portions of distinct elements A the terminal portions of which are inserted in respective seats 4 of the drum 3, and of conveyance of a portion of an additional conductive element A into a predefined seat 4 between the respective terminal portions of already-positioned elements A in respective seats 4 and mutually splayed by the movement.

The subsequent step of movement comprises an action of locking elements A that have been inserted in respective seats 4 of the drum 3 at the same time as the movement to splay the two portions A, so as to prevent movements induced by the splaying movement in elements A that are spaced apart from the splayed elements A.

Advantageously the present invention solves the above mentioned problems, by providing an assembly 1 for forming windings for electric machines that enables the easy insertion of the portions (in particular of the tines) of the electrically conductive elements A (such as for example “hairpins” provided with tines) into respective seats 4 by way of a gripper P actuated by a Cartesian movement apparatus (which therefore does not allow adjustments of the position of delivery of the elements A to the drum 3).

Conveniently the assembly 1 according to the invention makes it possible to execute positioning adjustments for the alignment of the portions (of the tines) of the elements A (hairpins) and of the respective seats 4 of the drum 3, by way of a movement of the drum 3 (which, in its most complete embodiment, entails a displacement along its plane of arrangement in two perpendicular directions and a rotation about its own axis of symmetry).

Profitably the assembly 1 according to the invention makes possible a reduction of the times of each cycle for picking and placing the electrically conductive elements A (hairpins) in the seats 4 of a model (or basket), i.e. the drum 3, that replicates the distribution of the slots of the destination stator (or rotor or other ferromagnetic core of an electric machine), with respect to what is possible in the known art. The higher speed is dictated by the combination of the use of a simple grip element P associated with a Cartesian movement apparatus that does not allow any adjustment (but is extremely fast) and of a drum 3 that can be translated on its plane of arrangement and rotated with respect to its own axis of symmetry: the movements of the drum 3 can be simultaneous with the movements of the grip element P and therefore they will not determine increases in the duration of the operating cycle.

Positively the assembly 1 according to the invention adopts components that are subjected to substantially simple control logic: in fact the movements of the drum 3 are achieved using distinct actuation systems (a rotatable actuator 7 designed to command the rotation of the drum 3 about its own axis, and a pair of mutually perpendicular linear actuators for the translations of the drum 3 on its plane of arrangement).

Usefully the assembly 1 according to the invention is particularly versatile, i.e. adapted to forming windings intended for different types of stators (or rotors) of electric machines. This is possible because the greater dimensions of the seats 4 (in particular their length, i.e. the extension in a radial direction with respect to the drum 3) with respect to conventional seats, and the possibility of moving the drum 3 on its plane of arrangement and of orienting it (by rotating it about its own axis of symmetry), ensure to adapt to numerous and distinct types of elements A and of inductive windings to be made.

Positively the assembly 1 according to the invention is easily and practically implemented and is of low cost: such characteristics make the assembly 1 according to the invention an innovation that is safe in use.

The invention thus conceived is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in Italian Patent Application No. 102022000004298 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-18. (canceled)

19. An assembly for forming windings for electric machines, which comprises:
a supporting frame,
a collection drum which has a central axis of symmetry and is supported on a plane of arrangement of said frame, said drum having a plurality of seats arranged according to a predefined distribution,
at least one grip element which is configured to pick up at least one electrically conductive element from a delivery station and to move the picked-up element up to the insertion at least of a portion of interest of the element in a seat of said drum,
each seat of said plurality of seats extending radially between an inner edge, arranged at a first predefined distance from the central axis of said drum, and an outer edge, arranged at a second predefined distance from the central axis of said drum which is greater than said first distance, wherein means for rotation are interposed between said drum and said frame and are configured to rotate said drum with respect to the central axis, and wherein said assembly comprises means for translation which are configured to translate said drum on the plane of arrangement so as to vary the position of the central axis of said drum on said plane of arrangement.

20. The assembly according to claim 19, wherein said means for rotation of said drum comprise a rotatable actuator for the rotation of said drum until an alignment of at least one respective seat thereof with at least one corresponding portion of interest of an element gripped by said grip element is obtained.

21. The assembly according to claim 19, wherein said means for translation of said drum on the plane comprise at least one linear actuator for a translation of said drum along at least one first direction defined on the plane of arrangement.

22. The assembly according to claim 21, wherein said means for translation of said drum on said plane of arrangement comprise two linear actuators which operate along two perpendicular directions for the translation of said drum respectively along said at least one first direction which is defined on the plane of arrangement of said drum and along at least one second direction which is perpendicular to and coplanar with said first direction.

23. The assembly according to claim 19, further comprising at least one slider which is configured move in a radial direction with respect to the central axis within each seat for compaction of the portions of said element that are present within said seat, said at least one slider being movable in a radial direction with respect to the central axis from one end of said seat up to a predefined position thereof, by virtue of an action of at least one respective actuator.

24. The assembly according to claim 23, further comprising two sliders which are configured to move in a radial direction with respect to the central axis, and are mutually opposite within each seat for the compaction of the portions of said elements that are present within said seat, a first slider being movable in a radial direction with respect to the central axis from an internal end of said seat up to a predefined internal position thereof, by virtue of the action of at least one respective actuator, and a second slider being movable in a radial direction with respect to the central axis from an external end of said seat up to a predefined external position thereof, by virtue of the action of at least one respective actuator, said portions of said elements being interposed and compacted between said sliders when said sliders are arranged respectively in said predefined internal position and said predefined external position.

25. The assembly according to claim 19, further comprising at least one splaying apparatus which is configured to move between a passive configuration, which is external to said drum, and an active configuration, in which a contoured edge thereof is at least partially overlaid on said drum and is interposed between contiguous central portions of elements terminal portions of which are inserted in respective seats of said drum, said splaying apparatus comprising a conveyance receptacle for a portion of an additional conductive element into a predefined seat, between said respective terminal portions, of already-positioned elements, which are mutually splayed by said contoured edge.

26. The assembly according to claim 25, further comprising a locking unit which is configured to move between an external, passive arrangement, separate from said drum, and an active arrangement in which the locking unit is partially overlaid on said drum, at which a terminal end of said locking unit abuts against mutually contiguous central portions of distinct elements terminal portions of which are inserted in respective seats of said drum, compressing the terminal portions onto each other inward into the respective seat.

27. The assembly according to claim 26, wherein said splaying apparatus and said locking unit abut against conductive elements portions of which are accommodated within respective seats of said drum, said splaying apparatus and said locking unit being substantially aligned, with a predefined mutual angular offset, with the seats provided for an insertion of respective portions of an additional conductive element clamped by said at least one grip element.

28. The assembly according to claim 19, wherein the grip element configured to move the element performs the insertion of at least one portion of interest of the element into a preset position with respect to the supporting frame.

29. The assembly according to claim 25, wherein said conveyance receptacle is configured as an opening having an orientation parallel to the seats in which the conductive elements are at least partially accommodated.

30. A method for forming windings for electric machines, which comprises the following steps:
picking up, using a grip element, at least one electrically conductive element from a delivery station,
moving an element up until an insertion at least of a portion of interest of said element in a seat of a plurality of seats of a drum, wherein each seat of said plurality of seats extends radially between an inner edge, arranged at a first predefined distance from a central axis of said drum, and an outer edge, arranged at a second predefined distance from the central axis of said drum and wherein said drum is supported by a plane of arrangement of said frame,
rotating the drum about a central axis of the drum on the plane of arrangement according to an angle of limited breadth,
said method comprising an additional step of translating the drum on the plane of arrangement so as to vary the position of the central axis of said drum on said plane of arrangement.

31. The method according to claim 30, wherein in the step of rotation, the drum rotates until an alignment of at least one respective seat thereof with at least one corresponding portion of interest of an element gripped by said grip element is obtained.

32. The method according to claim 19, wherein in the step of translation of the drum on the plane of arrangement, the translation occurs along at least one first direction defined on the plane of arrangement.

33. The method according to claim 19, wherein in the step of translation of the drum on the plane of arrangement, the translation occurs on two mutually perpendicular directions which are defined on the plane of arrangement.

34. The method according to claim 19, wherein said method comprises a subsequent step of compaction of the portions of said elements which are present in the seat, in a radial direction with respect to the central axis of rotation, from a bulky configuration to a less bulky configuration.

35. The method according to claim 34, further comprising a subsequent step of movement in order to splay two mutually radially contiguous central portions of distinct elements the terminal portions of which are inserted in respective seats of said drum, and of conveyance of a portion of an additional conductive element into a predefined seat between said respective terminal portions of already-positioned elements in respective seats and mutually splayed by the movement.

36. The method according to claim 35, wherein said subsequent step of movement comprises an action of locking elements that have been inserted in respective seats of the drum at the same time as the movement to splay the two portions, so as to prevent movements induced by said splaying movement in elements that are spaced apart from the splayed elements.
